(19) United States
(12) Patent Application Publication
(10) Pub. No.: US 2023/0185529 A1
(43) Pub. Date: Jun. 15, 2023

(54) CALCULATION SYSTEM

(71) Applicant: Kioxia Corporation, Tokyo (JP)

(72) Inventors: Radu BERDAN, Shinagawa (JP); Daisuke MIYASHITA, Kawasaki (JP); Jun DEGUCHI, Kawasaki (JP)

(73) Assignee: Kioxia Corporation, Tokyo (JP)

(21) Appl. No.: 17/840,691

(22) Filed: Jun. 15, 2022

(30) Foreign Application Priority Data
Dec. 15, 2021 (JP) 2021-203643

(51) Int. Cl. G06F 7/523; G06F 7/50; G06N 3/063

(52) U.S. Cl. CPC G06F 7/523; G06F 7/50; G06N 3/063

(57) ABSTRACT

According to one embodiment, in a calculation system, a plurality of multiplying elements is arrayed to form a plurality of rows and a plurality of columns and are configured to multiply a plurality of first signals by respective weights to generate a plurality of calculation results and are configured to calculate a sum of calculation results in each column among the plurality of calculation results to generate a plurality of second signals individually for the plurality of columns. A first processing circuit is configured to receive the plurality of second signals generated by the adding elements, and to extract values corresponding to certain second signals among the plurality of second signals. A second processing circuit including a plurality of address circuits corresponding to the plurality of second signals, and configured to selectively enable address circuits corresponding to the certain second signals among the plurality of address circuits.

### CROSS-REFERENCE TO RELATED APPLICATIONS

This application is based upon and claims the benefit of priority from Japanese Patent Application No. 2021-203643, filed on Dec. 15, 2021; the entire contents of which are incorporated herein by reference.

### FIELD

Embodiments described herein relate generally to a calculation system.

### BACKGROUND

In a calculation system, there is a case where predetermined arithmetic operations are performed and a plurality of signals are generated as arithmetic operation results. In the calculation system, it is desirable that the plurality of signals thus generated should be usable efficiently.

### BRIEF DESCRIPTION OF THE DRAWINGS

FIG. 1 is a diagram illustrating a schematic configuration of a neural network in a first embodiment;

FIG. 2 is a diagram illustrating a concrete configuration of a calculation system in the first embodiment;

FIG. 3 is a circuit diagram illustrating a configuration of a processing circuit in the first embodiment;

FIG. 4 is a waveform diagram illustrating an operation of the processing circuit in the first embodiment;

FIG. 5 is a diagram illustrating input and output signals of an address solution circuit in the first embodiment;

FIG. 6 is a diagram illustrating a configuration of the address solution circuit in the first embodiment;

FIG. 7 is a circuit diagram illustrating a configuration of an address circuit and a register circuit in the first embodiment;

FIG. 8 is a circuit diagram illustrating a configuration of a storage circuit in the first embodiment;

FIG. 9 is a circuit diagram illustrating a configuration of a tri-state inverter in the first embodiment;

FIG. 10 is a waveform diagram illustrating an operation of the address solution circuit in the first embodiment;

FIGS. 11A to 11C are circuit diagrams illustrating examples of operations of the address solution circuit in the first embodiment;

FIGS. 12A and 12B are circuit diagrams illustrating other examples of operations of the address solution circuit in the first embodiment;

FIG. 13 is a circuit diagram illustrating a configuration of a processing circuit in a second embodiment;

FIG. 14 is a waveform diagram illustrating an operation of the processing circuit in the second embodiment;

FIG. 15 is a diagram illustrating input and output signals of an address solution circuit in the second embodiment;

FIG. 16 is a diagram illustrating a configuration of the address solution circuit in the second embodiment; and

FIG. 17 is a waveform diagram illustrating an operation of the address solution circuit in the second embodiment.

### DETAILED DESCRIPTION

In general, according to one embodiment, there is provided a calculation system including a plurality of multiplying elements, a plurality of adding elements, a first processing circuit and a second processing circuit. The plurality of multiplying elements is arrayed to form a plurality of rows and a plurality of columns. The plurality of multiplying elements is configured to multiply a plurality of first signals by respective weights to generate a plurality of calculation results. The plurality of adding elements are configured to calculate a sum of calculation results in each column among the plurality of calculation results to generate a plurality of second signals individually for the plurality of columns. The first processing circuit is configured to receive the plurality of second signals generated by the adding elements, and to extract values corresponding to certain second signals among the plurality of second signals. The second processing circuit including a plurality of address circuits corresponding to the plurality of second signals, and configured to selectively enable address circuits corresponding to the certain second signals among the plurality of address circuits.

Exemplary embodiments of a calculation system will be explained below in detail with reference to the accompanying drawings. The present invention is not limited to the following embodiments.

### First Embodiment

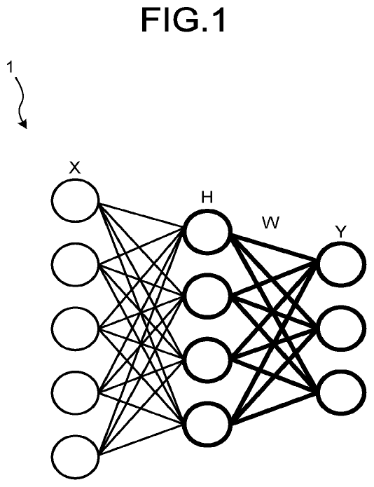

A calculation system 1 according to a first embodiment includes, for example, a circuit that performs part of the processing of a neural network. As illustrated in FIG. 1, the neural network includes a plurality intermediate layers H between an input layer X and an output layer Y. FIG. 1 is a diagram illustrating a schematic configuration of the neural network for which the calculation system 1 performs part of the processing. For simplification, FIG. 1 illustrates the intermediate layers H as one layer. As illustrated in FIG. 1, signals from a plurality of neurons of the intermediate layer H (all neurons in FIG. 1) are input to each neuron of the output layer Y to perform processing. The processes in respective neurons are carried out in parallel. The specific arithmetic operation performed in this series of processing is to perform a vector-matrix multiplication between a vector of input values and a matrix of weights, for example. In addition, in the neural network, there is a case where an arithmetic operation is performed to find the upper K values among the values calculated in a plurality of neurons of a certain layer.

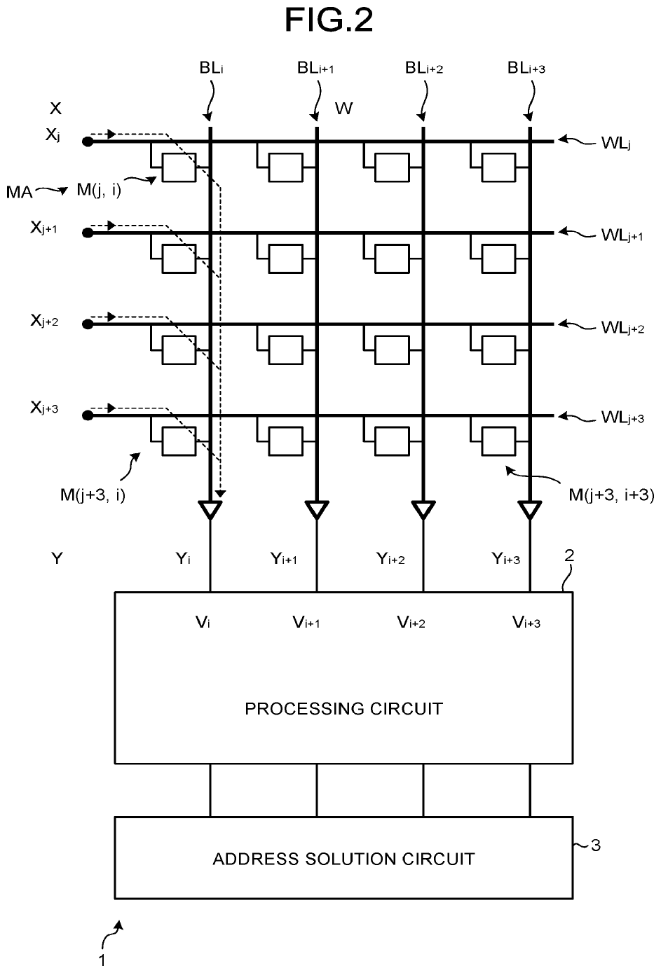

FIG. 2 is a diagram illustrating a concrete configuration of the calculation system 1 according to this embodiment. The calculation system 1 according to this embodiment performs calculations for a plurality of neurons of a certain layer in the neural network in parallel, perform processing to find some upper K values from the calculated values, and further performs processing to find the addresses of the upper K values. The calculations for a plurality of neurons of a certain layer in the neural network can be realized by a crossbar array configuration of a plurality of multiplying elements as illustrated in FIG. 2, in which an arithmetic operation for activation of neuron data can be performed by physical signals.

The calculation system 1 illustrated in FIG. 2 includes a plurality of word lines WLj to WLj+3, a plurality of bit lines BLi to BLi+3, a memory array MA, a processing circuit 2, and an address solution circuit 3.

The memory array MA includes a plurality of memories M(j, i) to M(j+3, i+3). In the memory array MA, a plurality of memories M(j, i) to M(j+3, i+3) are arranged, in a matrix format, at the positions where the plurality of word lines WLj to WLj+3 intersect with the plurality of bit lines BLi to BLi+3 (each of “i” and “j” is an integer greater than or equal to 1). Here, FIG. 2 illustrates the (j)th row to the (j+3)th row and the (i)th column to the (i+3)th column (4 rows×4 columns). However, this is not limiting, but may be set to include any number of rows and any number of columns. The processing circuit 2 is connected to each end of the plurality of bit lines BLi to BLi+3. The address solution circuit 3 is connected to the processing circuit 2 on the opposite side of the plurality of bit lines BLi to BLi+3. The address solution circuit 3 is a circuit to find column addresses and may also be called as an address finder 3.

Each of the memories M(j, i) to M(j+3, i+3) has one end connected to a word line WL and the other end connected to a bit line BL. Each of the memories M(j, i) to M(j+3, i+3) is a resistance change type memory, for example, in which the resistance state can be set to a resistance value according to the corresponding one of weights W_{j, i} to W_{j+3, i+3}. The resistance values of the respective memories M(j, i) to M(j+3, i+3) can be set to, for example, 1/W_{j, i} to 1/W_{j+3, i+3}. Each of the memories M(j, i) to M(j+3, i+3) functions as a multiplying element that multiplies a received signal by the corresponding one of the weights W_{j, i} to W_{j+3, i+3}, and generates a signal of the multiplication result. In each of the memories M(j, i) to M(j+3, i+3), the voltage X of the word line WL is applied to one end, and, in accordance with the voltage X of the word line WL and the set weight W, a current is caused to flow through the bit line BL as a multiplication result. The currents of the memories M in each column are added up on the bit line BL and form a current Y as an addition result. That is, each of the bit lines BLi to BLi+3 functions as an adding element that adds up signals from a plurality of memories M arranged in the column direction.

For example, as shown by dotted line arrows in FIG. 2, the voltage Xⱼ of the word line WLj of the (j)th row is applied to one end of the memory M(j, i), and a current Xⱼ×W_{j, i} is caused to flow from the other end of the memory M(j, i) to the bit line BLi of the (i)th column. The voltage Xⱼ₊₃ of the word line WLj+3 of the (j+3)th row is applied to one end of the memory M(j+3, i), and a current Xⱼ₊₃×W_{j+3, i} is caused to flow from the other end of the memory M(j+3, i) to the bit line BLi of the (i)th column. The currents Xⱼ×W_{j, i} to Xⱼ₊₃×W_{j+3, i} are added up on the bit line BLi, and become, as an addition result, a current Yᵢ (=Xⱼ×W_{j, i}+Xⱼ₊₁×W_{j+1, i}+Xⱼ₊₂×W_{j+2, i}+Xⱼ₊₃×W_{j+3, i}) .

Alternatively, although not illustrated, the voltage Xⱼ of the word line WLj of the (j)th row is applied to one end of the memory M(j, i+3), and a current Xⱼ×W_{j, i+3} is caused to flow from the other end of the memory M(j, i+3) to the bit line BLi+3 of the (i+3)th column. The voltage Xⱼ₊₃ of the word line WLj+3 of the (j+3)th row is applied to one end of the memory M(j+3, i+3), and a current Xⱼ₊₃×W_{j+3, i+3} is caused to flow from the other end of the memory M(j+3, i+3) to the bit line BLi+3 of the (i+3)th column. The currents Xⱼ×W_{j, i+3} to Xⱼ₊₃×W_{j+3, i+3} are added up on the bit line BLi+3, and become, as an addition result, a current Yᵢ₊₃ (=Xⱼ×W_{j, i+3}+Xⱼ₊₁×W_{j+1, i+3}+Xⱼ₊₂×W_{j+2, i+3}+Xⱼ₊₃×W_{j+3, i+3}) .

The processing circuit 2 is supplied with the currents Yᵢ to Yᵢ₊₃ through the bit lines BLi to BLi+3. The currents Yᵢ to Yᵢ₊₃ correspond to voltages Vᵢ to Vᵢ₊₃ to be accumulated in the input nodes to the processing circuit 2. Each of the voltages Vᵢ to Vᵢ₊₃ is an analog signal representing a product-sum operation result for each column. In the processing circuit 2, an analog signal (voltage V) is AD-converted to a digital signal for each column by the processing circuit 2. The processing circuit 2 extracts digital signals of the upper K values from the digital signals of the plurality of columns, and generates a plurality of upper flag values. The plurality of upper flag values corresponds to the digital signals of a plurality of columns. Each of the upper flag values indicates whether the corresponding signal is a part of the upper K values or not.

The address solution circuit 3 includes a plurality of address circuits that correspond to a plurality of columns. Each address circuit is configured to output an address signal. The address signal indicates the address of the corresponding column. The address solution circuit 3 obtains a plurality of upper flag values from the processing circuit 2. In accordance with the plurality of upper flag values, the address solution circuit 3 selectively enables the address circuits corresponding to the upper K digital signals among the plurality of address circuits. The address solution circuit 3 causes address signals to be sequentially output from the K address circuits each enabled.

As a result, for the upper K digital signals, the address solution can be performed by processing in K cycles. Therefore, the address solution can be performed more efficiently as compared with a case where the address solution is performed by processing in cycles corresponding to the number of columns.

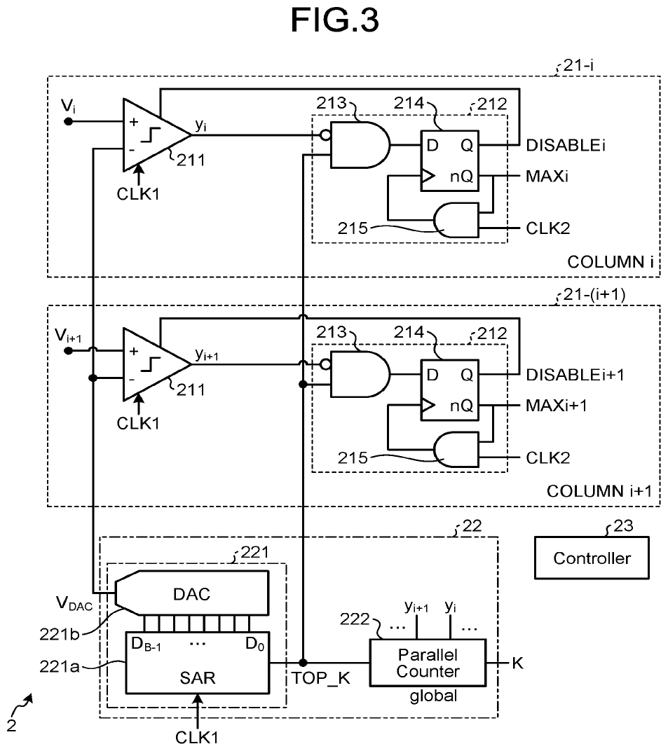

Next, an explanation will be given of the configuration of the processing circuit 2 with reference to FIG. 3. FIG. 3 is a circuit diagram illustrating a configuration of the processing circuit 2.

The processing circuit 2 performs a plurality of AD-conversion operations of the SAR(Successive Approximation Register)-type in parallel, to the signals that correspond to multiplication results in the plurality of columns and have been received from the plurality of bit lines BL, while searching for the upper K signals among the signals. The processing circuit 2 includes a plurality of local circuits 21-i, 21-(i+1), etc., a global circuit 22, and a controller 23. The global circuit 22 includes a DAC 221 for the global SAR and a parallel counter 222.

For simplification, FIG. 3 illustrates the local circuit 21-i for the (i)th column and the local circuit 21-(i+1) for the (i+1)th column. However, the processing circuit 2 may include any number of local circuits in accordance with the number of columns in the array of the multiplying elements M.

The local circuit 21 for each column includes a comparator 211 and a logic circuit 212. The logic circuit 212 includes an AND gate 213, a flip-flop 214, and an AND gate 215. The local circuits 21 for the respective columns have the same configuration.

The comparator 211 compares an input signal Vᵢ₊₁ with a global reference signal V_{DAC} supplied by the DAC 221 for the global SAR. The comparator 211 outputs a local signal yᵢ, yᵢ₊₁, which has been binarized (L/H or 0/1), as a comparison result in accordance with a clock CLK1. The comparator 211 receives a disable signal DISABLEᵢ, DISABLEᵢ₊₁ from the logic circuit 212. The comparator 211 is disabled in accordance with the disable signal DISABLEᵢ, DISABLEᵢ₊₁.

The AND gate 213 calculates a logical product between a logically inverted signal of the local signal yᵢ, yᵢ₊₁ and a global signal TOP_K, and outputs the calculation result to the flip-flop 214. The AND gate 215 calculates a logical product between an upper flag MAXᵢ, MAXᵢ₊₁ and a clock CLK2, and outputs the calculation result to the flip-flop 214 as a clock signal. The flip-flop 214 receives the calculation result of the AND gate 213 at a data input terminal D and receives the calculation result of the AND gate 215 at a clock input terminal.

The flip-flop 214 outputs, from an inversion output terminal nQ, an upper flag MAXᵢ, MAXᵢ₊₁, which indicates whether a signal Vᵢ, Vᵢ₊₁ of the corresponding column can be a signal among the upper K values, among the signals V of the plurality of columns input to the processing circuit 2. The flip-flop 214 may be a latch circuit. The flip-flop 214 outputs, from a non-inversion output terminal Q, a disable signal DISABLEᵢ, DISABLEᵢ₊₁ for disabling the comparator 211 when the signal Vᵢ, Vᵢ₊₁ of the corresponding column cannot be a signal among the upper K values. The disable signal DISABLEᵢ, DISABLEᵢ₊₁ can be used to limit (power gating) the power to be consumed by a plurality of comparators 211 during a sequential comparison (SAR) operation by the processing circuit 2.

The flip-flop 214 operates in synchronization with a clock signal output from the AND gate 215. The AND gate 215 is provided to restrict the clock CLK2 (clock gating) so as to prevent the state of the disable signal DISABLEᵢ, DISABLEᵢ₊₁ from changing when the upper flag MAXᵢ, MAXᵢ₊₁ is at the L level. That is, when the upper flag MAX is at the L level, the flip-flop 214 of a column, in which the comparator 211 has been disabled, keeps the disable signal DISABLE at the H level and keeps the upper flag MAX at the L level, in accordance with the clock signal received by the clock input terminal being fixed at the L level.

The inversion input terminals (−) of the comparators 211 for the respective columns are driven in parallel by the DAC 221 for the global SAR, and the signals V are sequentially processed from the most significant bit (MSB) to the least significant bit (LSB) in accordance with the SAR algorithm. The DAC 221 for the global SAR includes a global SAR register 221a and a global DAC 221b. The global SAR register 221a is a shift register including registers at a plurality of stages, in which the input value and the value at each stage are shifted in synchronization with the clock CLK1. The global SAR register 221a is configured to store “1” as the initial value in the register at the top stage at the time of its startup. The global DAC 221b receives the value at each stage of the shift register, performs DA conversion thereon, and outputs the converted analog voltage as the global reference signal V_{DAC}.

Here, the controller 23 may be a local controller provided individually for each column, or may be a global controller provided for the respective columns in common. In FIG. 3, the controller 23 is illustrated as the global controller. The controller 23 controls processing related to timing, resetting, and state transition. For example, the controller 23 generates the clock CLK1, and supplies this clock to the comparator 211 for each column and the global SAR register 221a. The controller 23 generates the clock CLK2 and supplies this clock to the AND gate 215 for each column. The clock CLK2 is a clock in which the clock CLK1 is logically inverted.

The input that determines the SAR transition in the global SAR register 221a is driven by the parallel counter 222.

The parallel counter 222 counts how many outputs among the local signals yᵢ, yᵢ₊₁, etc. output from the comparators 211 of the respective columns are at the H level (or 1), in each DA conversion cycle, and outputs the global signal TOP_K to the AND gate 213 for each column and the global SAR register 221a in accordance with the counted value. When the global signal TOP_K is supplied, the global SAR register 221a stores the value of the global signal TOP_K in the register at the first stage, and shifts the value held in the register at each stage.

In searching for the upper K values, the parallel counter 222 outputs the global signal TOP_K=H level (or 1) when the counted value is greater than or equal to K, and outputs the global signal TOP_K=L level (or 0) when the counted value is smaller than K. The concrete configuration of the parallel counter 222 may be implemented by a digital circuit or may be implemented by an analog circuit.

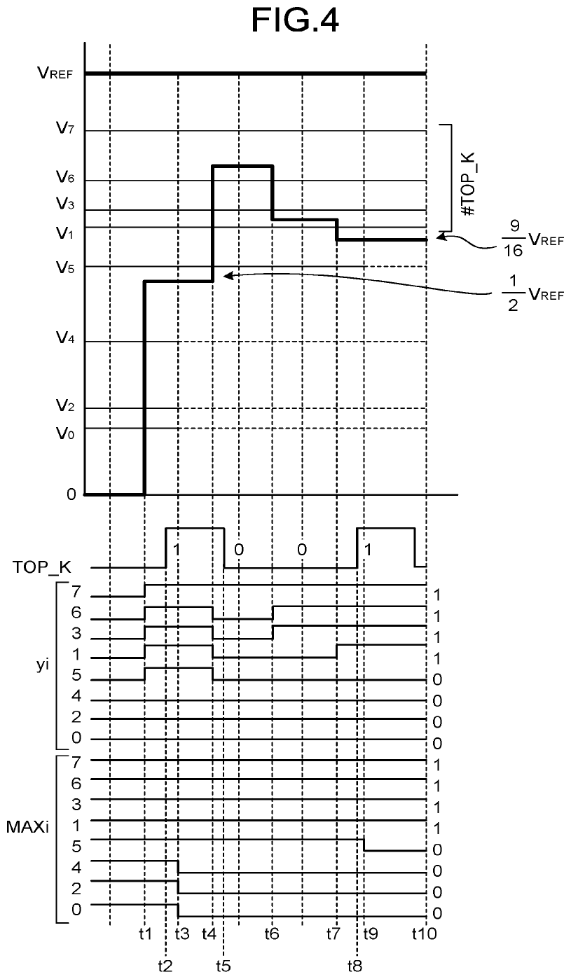

For example, the processing circuit 2 is operated as illustrated in FIG. 4. FIG. 4 is a waveform diagram illustrating an operation of the processing circuit 2. In the upper part of FIG. 4, the vertical axis indicates the magnitude of voltage and the horizontal axis indicates time. In the lower part of FIG. 4, the vertical axis indicates the level of each signal (for example, the H level or L level), and the horizontal axis indicates time. In the upper and lower parts of FIG. 4, the horizontal axes indicate the same time. FIG. 4 illustrates an operation in which the processing circuit 2 that has received the signals V₀ to V₇ of the 0th column to the 7th column searches for the upper K=4 values while performing AD-conversion with a precision of 4 bits.

At timing t1, the DAC 221 for the global SAR sets the global reference voltage V_{DAC}=V_{REF}/2. The comparators 211 for the respective columns (the 0th column to the 7th column) compare the signals V₀ to V₇ with the global reference voltage V_{DAC}=V_{REF}/2, and output local signals (y₀, y₁, y₂, y₃, y₄, y₅, y₆, y₇)=(0, 1, 0, 1, 0, 1, 1, 1) as comparison results.

At timing t2, the parallel counter 222 counts the number of local signals whose value is 1, and causes the global signal TOP_K to transition from the L level (or 0) to the H level (or 1) since the counted value=5 is greater than or equal to K=4.

At timing t3, the logic circuit 212 for each of the 0th, 2nd, and 4th columns (i=0, 2, 4) changes the upper flag MAXᵢ from H (or 1) to L (or 0) and changes the disable signal DISABLEᵢ from L (or 0) to H (or 1), in light of the state where the signal Vᵢ cannot be one of the upper K because the local signal yᵢ=0 and the global signal TOP_K=1. Consequently, as shown by a dotted line in the waveform of the signal Vᵢ, the comparator 211 for each of the 0th, 2nd, and 4th columns receives the disable signal DISABLEᵢ=H (or 1) and is disabled in operation. Therefore, the power consumption of the comparator 211 is stopped (power gating).

On the other hand, the logic circuit 212 for each of the 1st, 3rd, and 5th to 7th columns (i=1, 3, 5 to 7) keeps the upper flag at MAXᵢ=H (or 1) and keeps the disable signal at DISABLEᵢ=L (or 0), in light of the state where the signal Vᵢ can be one of the upper K because the local signal yᵢ=1 and the global signal TOP_K=1.

At timing t4, the DAC 221 for the global SAR sets the global reference voltage V_{DAC}=3V_{REF}/4. Each of the comparators 211 for the 1st, 3rd, 5th, and 6th columns (i=1, 3, 5, 6) outputs the local signal yᵢ=0, and, at timing t5, the global signal TOP_K=0 is made. This means that the number of signals higher than the global reference signal V_{DAC} is smaller than K. In this case, since it is not possible to determine which signal of a plurality of signals V₁, V₃, V₅ to V₇ belongs to the upper K signals, the determination is suspended.

At timing t6, the DAC 221 for the global SAR sets the global reference voltage V_{DAC}=5V_{REF}/8. Although the comparator 211 for each of the 3rd and 6th columns (i=3, 6) outputs the local signal yᵢ=1, as the comparator 211 for each of the 1st and 5th columns (i=1, 5) outputs the local signal yᵢ=0, the global signal TOP_K=0 is kept. This means that the number of signals higher than the global reference signal V_{DAC} is still smaller than K. Also in this case, the determination is kept suspended.

At timing t7, the DAC 221 for the global SAR sets the global reference voltage V_{DAC}=9V_{REF}/16. The comparators 211 for the respective columns (the 1st, 3rd, and 5th to 7th columns) not disabled at this time compare the signals V₁, V₃, and V₅ to V₇ with the global reference voltage V_{DAC}=9V_{REF}/16, and output local signals (y₁, y₃, y₅, y₆, y₇)=(1, 1, 0, 1, 1) as comparison results.

At timing t8, the parallel counter 222 counts the number of local signals whose value is 1, and causes the global signal TOP_K to transition from the L level (or 0) to the H level (or 1) since the counted value=4 is greater than or equal to K=4.

At timing t9, the logic circuit 212 for the 5th column (i=5) changes the upper flag MAXᵢ from H (or 1) to L (or 0) and changes the disable signal DISABLEᵢ from L (or 0) to H (or 1), in light of the state where the signal Vᵢ cannot be one of the upper K because the local signal yᵢ=0 and the global signal TOP_K=1. Consequently, as shown by a dotted line in the waveform of the signal Vᵢ, the comparator 211 for the 5th column receives the disable signal DISABLEᵢ=H (or 1) and is disabled in operation. Therefore, the power consumption of the comparator 211 is stopped (power gating).

On the other hand, the logic circuit 212 for each of the 1st, 3rd, 6th, and 7th columns (i=1, 3, 6, 7) keeps the upper flag at MAXᵢ=H (or 1) and keeps the disable signal at DISABLEᵢ=L (or 0), in light of the state where the signal Vᵢ can be one of the upper K because the local signal yᵢ=1 and the global signal TOP_K=1.

When B denotes the number of bits according to the precision of conversion, the processing circuit 2 outputs, at timing t10 after B=4 cycles, the upper flags (MAX₀, MAX₁, MAX₂, MAX₃, MAX₄, MAX₅, MAX₆, MAX₇)=(0, 1, 0, 1, 0, 0, 1, 1) as the result of searching for the upper K values to the address solution circuit 3. In this example, it is illustrated that, as the searching result, the signals V₁, V₃, V₆, and V₇ of the 1st, 3rd, 6th, and 7th columns have been found as the upper K values among the signals V₀ to V₇ of the 0th column to the 7th column.

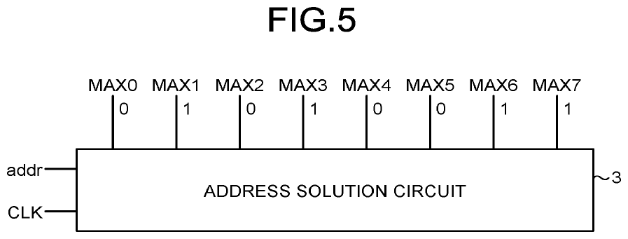

The address solution circuit 3 illustrated in FIG. 5 receives the upper flags (MAX₀, MAX₁, MAX₂, MAX₃, MAX₄, MAX₅, MAX₆, MAX₇)=(0, 1, 0, 1, 0, 0, 1, 1) from the processing circuit 2, and receives the clock CLK from the outside (for example, a controller not illustrated). FIG. 5 is a diagram illustrating the input and output signals of the address solution circuit 3. FIG. 5 illustrates a case where the number of columns is 8. The address solution circuit 3 may logically invert the upper flags MAX to generate inversion upper flags (MAX₀ , MAX₁ , MAX₂ , MAX₃ , MAX₄ , MAX₅ , MAX₆ , MAX₇ )=(1, 0, 1, 0, 1, 1, 0, 0). The address solution circuit 3 can use the upper flags MAX, the inversion upper flags MAX , and the clock CLK to perform the address solution for the signals corresponding to the upper flags MAX₀ to MAX₇, and thereby sequentially output the upper K address signals to an address bus addr<0:7>.

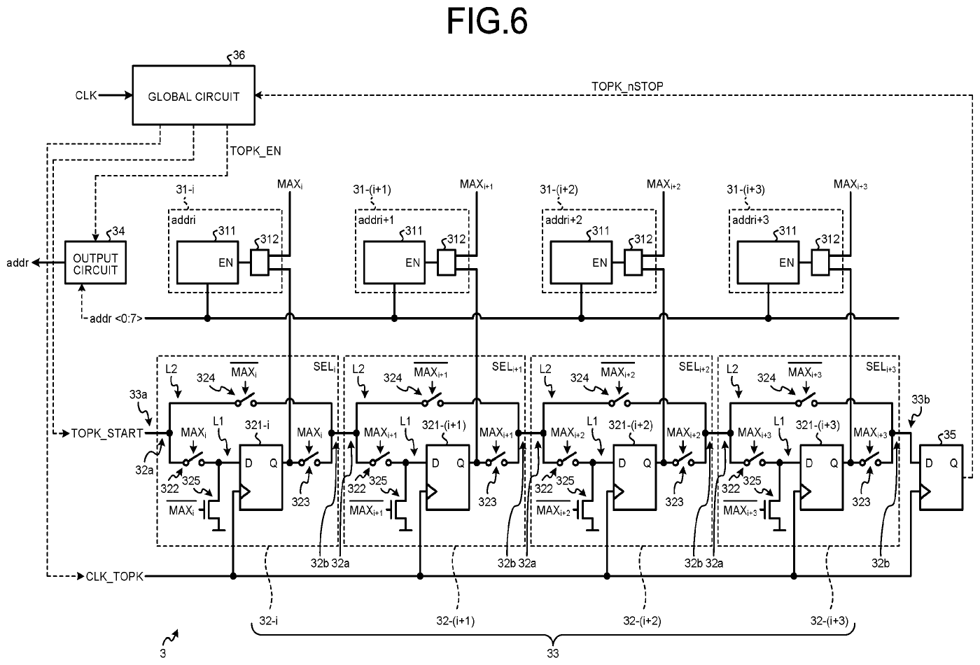

The address solution circuit 3 may be configured as illustrated in FIG. 6. FIG. 6 is a circuit diagram illustrating a schematic configuration of the address solution circuit 3. FIG. 6 illustrates a configuration that corresponds to the (i)th to (i+3)th columns (the number of columns is 4) in the array of a plurality of memories M(j, i) to M(j+3, i+3). However, this is not limiting but may have a configuration corresponding to any number of columns in accordance with the array of the memories M.

As illustrated in FIG. 6, the address solution circuit 3 includes, in addition to a plurality of address circuits 31-i to 31-(i+3), a shift register 33, an output circuit 34, a transfer detection circuit 35, and a global circuit 36.

The plurality of address circuits 31-i to 31-(i+3) respectively correspond to the plurality of columns (the (i)th to (i+3)th columns) of the memory array MA. The shift register 33 includes a plurality of register circuits 32-i to 32-(i+3). The plurality of register circuits 32-i to 32-(i+3) are connected in series between an input node 33a and an output node 33b. Each register circuit 32 includes a register 321. The register 321 may be formed of a flip-flop. The plurality of register circuits 32-i to 32-(i+3) respectively correspond to the plurality of address circuits 31-i to 31-(i+3).

The global circuit 36 receives the clock CLK from the outside, and generates a clock CLK_TOPK, an enable signal TOPK_EN, and a pulse TOPK_START in accordance with the clock CLK. In synchronization with the clock CLK, the global circuit 36 sets the enable signal TOPK_EN to the active level and supplies this signal to the output circuit 34. The output circuit 34 is activated in accordance with the enable signal TOPK_EN being at the active level, and comes into a state ready to output signals present on the address bus addr<0:7> as address signals addr.

In response to the enable signal TOPK EN changing to the active level, the global circuit 36 supplies the pulse TOPK_START to the register circuit 32-i at the top of the shift register 33. The global circuit 36 logically inverts the clock CLK to generate the clock CLK_TOPK, and supplies the clock CLK_TOPK to the register 321 of each register circuit 32.

The shift register 33 may be reconfigured in accordance with the upper flags MAXᵢ of the plurality of columns. The address solution circuit 3 connects the register 321 between the input node 32a and the output node 32b, in each of the register circuits 32 corresponding to the upper K upper flag values among the plurality of register circuits 32-i to 32-(i+3). The address solution circuit 3 bypasses the register 321 between the input node 32a and the output node 32b, in each of the remaining register circuits 32. With this arrangement, the address solution circuit 3 reconfigures the shift register 33.

The reconfigured shift register 33 receives an input of the pulse TOPK_START, which is supplied alone. The shift register 33 transmits the pulse TOPK_START by sequentially shifting this pulse between the registers 321 corresponding to the upper K upper flag values. Correspondingly, the address circuits 31 corresponding to the upper K upper flag values among the plurality of address circuits 31-i to 31-(i+3) are selectively and sequentially enabled. Consequently, the address signals are sequentially output from the address circuits 31 corresponding to the upper K upper flag values to the address bus addr<0:7>. That is, the shift register 33 may be reconfigured such that the address solution for the K address signals corresponding to the upper K signals can be performed in K cycles. Therefore, the address solution circuit 3 can be configured in a scalable manner for the “K” number of uppers and may perform a scalable address solution with K cycles for the upper K values.

The respective register circuits 32 are switchable between a first connection state and a second connection state in accordance with the upper flags MAXᵢ to MAXᵢ₊₃ and the inversion upper flags MAXᵢ to MAXᵢ₊₃ . The first connection state is a state where the corresponding register 321 is connected between the input node 32a and the output node 32b. The second connection state is a state where the corresponding register 321 is bypassed between the input node 32a and the output node 32b.

Upon reception of the pulse TOPK START from the final register circuit 32-(i+3), the transfer detection circuit 35 generates a pulse TOPK_nSTOP indicating that the transfer of the pulse TOPK_START in the shift register 33 is completed, and supplies the pulse TOPK_nSTOP to the global circuit 36. The transfer detection circuit 35 may be formed of a flip-flop. Upon reception of the pulse TOPK_nSTOP, the global circuit 36 sets the enable signal TOPK_EN to the non-active level, and supplies this signal to the output circuit 34. The output circuit 34 is deactivated in accordance with the enable signal TOPK_EN being at the non-active level, and comes into a state not to output signals present on the address bus addr<0:7>.

Each of the plurality of address circuits 31-i to 31-(i+3) can store an address signal fixedly, and may be configured using a hard-wired circuit. Each address circuit 31 includes a storage circuit 311 and an enable circuit 312.

The storage circuit 311 stores the address signal. The storage circuit 311 may store the address signal fixedly.

The enable circuit 312 can enable or disable the storage circuit 311 in accordance with the corresponding one of the upper flag values MAXᵢ to MAXᵢ₊₃ and the connection state of the corresponding register circuit 32. When the storage circuit 311 is enabled, a state is formed to output the address signal from the storage circuit 311 to the address bus addr<0:7>. When the storage circuit 311 is disabled, a state is formed not to output the address signal from the storage circuit 311 to the address bus addr<0:7>. The state may be a state where the outputs are set to high impedance, disconnecting the storage circuit 311 from the address bus addr<0:7>.

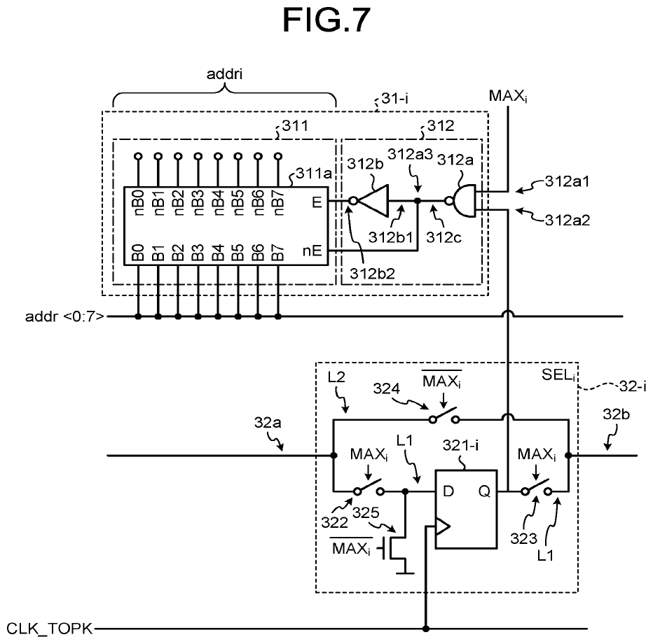

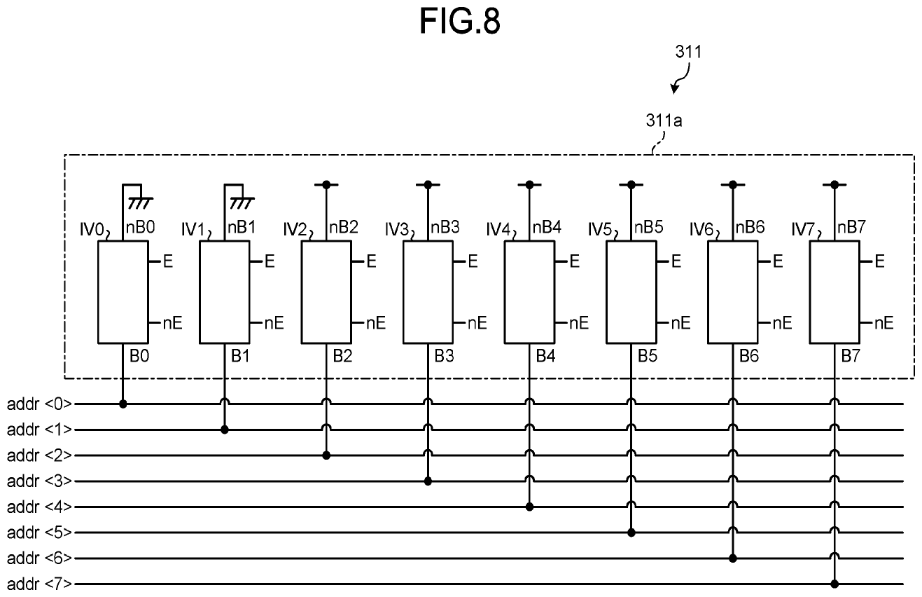

For example, when to store an 8-bit address, the storage circuit 311 for the (i)th column may include a hard-wired circuit 311a, as illustrated in FIGS. 7 and 8. FIG. 7 is a circuit diagram illustrating a configuration of the address circuit 31 and the register circuit 32 corresponding to the (i)th column. The address solution circuit 3 includes a configuration corresponding to a plurality of columns (in the case of FIG. 6, the (i)th to (i+3)th columns). Thus, FIG. 7 can be seen as illustrating the unit configuration for one column. FIG. 8 is a circuit diagram illustrating a configuration of the storage circuit 311. The hard-wired circuit 311a illustrated in FIG. 8 includes a plurality of tri-state inverters IV0 to IV7, a plurality of lines B0 to B7, a plurality of lines nB0 to nB7, a common line E, and a common line nE.

The plurality of lines nB0 to nB7, the plurality of tri-state inverters IV0 to IV7, and the plurality of lines B0 to B7 correspond to each other. The line nB0, the tri-state inverter IV0, and the line B0 correspond to the LSB of the address, and the line nB7, the tri-state inverter IV7, and the line B7 correspond to the MSB of the address. Each of the common line E and the common line nE are shared by the plurality of tri-state inverters IV0 to IV7. The plurality of lines B0 to B7 respectively correspond to a plurality of address lines addr<0> to addr<7> contained in the address bus.

Each of the lines nB0 to nB7 is connected by hard-wired connection to a fixed potential according to the address signal. The example of FIG. 8 illustrates a case where the storage circuit 311 stores an address 00000011b (“3” in decimal notation) fixedly. In the hard-wired circuit 311a of the storage circuit 311, the lines nB0 and nB1 are fixedly connected to the ground potential, and the lines nB2 to nB7 are fixedly connected to the power supply potential Vdd. The ground potential corresponds to the L level or level “0”, and the power potential Vdd corresponds to the H level or level “1”. The lines nB0 to nB7 are respectively set with levels of (nB0, nB1, nB2, nB3, nB4, nB5, nB6, nB7)=(0, 0, 1, 1, 1, 1, 1, 1). Each of the lines B0 to B7 is connected to the corresponding line nB via the corresponding tri-state inverter IV.

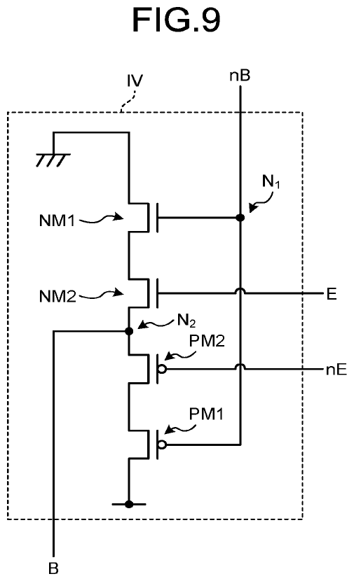

Each of the tri-state inverters IV0 to IV7 may be configured as illustrated in FIG. 9. FIG. 9 is a circuit diagram illustrating a configuration of the tri-state inverter IV.

The tri-state inverter IV includes an NMOS transistor NM1, an NMOS transistor NM2, a PMOS transistor PM1, and a PMOS transistor PM2. The NMOS transistor NM1 and the PMOS transistor PM1 are inverter-connected and share a common input node N1 and a common output node N2. The NMOS transistor NM2 and the PMOS transistor PM2 are inserted to the output node N2 of the inverter connection as a switch for activating/deactivating the inverter connection.

The NMOS transistor NM1 is connected between the ground potential and the NMOS transistor NM2. The NMOS transistor NM2 is connected between the NMOS transistor NM1 and the PMOS transistor PM2. The PMOS transistor PM2 is connected between the NMOS transistor NM2 and the PMOS transistor PM1. The PMOS transistor PM1 is connected between the PMOS transistor PM2 and the power supply potential Vdd.

In the NMOS transistor NM1, the source is connected to the ground potential, the drain is connected to the NMOS transistor NM2, and the gate is connected to the line nB via the input node N1.

In the NMOS transistor NM2, the source is connected to the NMOS transistor NM1, the drain is connected to the line B via the output node N2, and the gate is connected to the line E.

In the PMOS transistor PM1, the source is connected to the power supply potential, the drain is connected to the PMOS transistor PM2, and the gate is connected to the line nB via the input node N1.

In the PMOS transistor PM2, the source is connected to the PMOS transistor PM1, the drain is connected to the line B via the output node N2, and the gate is connected to the line nE.

Each of the tri-state inverters IV0 to IV7 is activated and operates as an inverter, when the level of the common line E is set to the active level (for example, the H level), and the common line nE is set to the active level (for example, the L level). In the example illustrated in FIG. 8, when the common lines E and nE are set to their respective active levels, the lines B0 to B7 respectively output levels of (B0, B1, B2, B3, B4, B5, B6, B7)=(1, 1, 0, 0, 0, 0, 0, 0) as address signals to the corresponding address lines addr. In this example, since B0 corresponds to the LSB and B7 corresponds to the MSB, the address value is “00000011” in binary notation and “3” in decimal notation.

Each of the tri-state inverters IV0 to IV7 is deactivated and stops the operation as the inverter, when the level of the common line E is set to the non-active level (for example, the L level), and the common line nE is set to the non-active level (for example, the H level). In the example illustrated in FIG. 8, when the common lines E and nE are set to their respective non-active levels, the lines B0 to B7 respectively become levels of (B0, B1, B2, B3, B4, B5, B6, B7)=(HiZ, HiZ, HiZ, HiZ, HiZ, HiZ, HiZ, HiZ), and do not output address signals. Here, “HiZ” stands for high impedance.

Returning to FIG. 7, the enable circuit 312 for the (i)th column includes a NAND gate 312a and an inverter 312b. The NAND gate 312a includes an input node 312a1 connected to the local circuit 21-i for the (i)th column of the processing circuit 2, an input node 312a2 connected to the register circuit 32-i for the (i)th column, and an output node 312a3 connected to a node 312c. The inverter 312b includes an input node 312b1 connected to the node 312c and an output node 312b2 connected to the line E. The node 312c is connected to the NAND gate 312a and the inverter 312b, and is further connected to the line nE.

The register circuit 32 for the (i)th column includes, in addition to the register 321, a signal line L1, a bypass line L2, a switch 322, a switch 323, a switch 324, and a switch 325. The register 321-i may be formed of a flip-flop. The switch 322, the switch 323, and the switch 324 are examples of switching elements, and are formed of transistors, for example.

The signal line L1 and the bypass line L2 are connected in parallel to each other between the input node 32a and the output node 32b. The signal line L1 includes a first end connected to the input node 32a and a second end connected to the output node 32b. The bypass line L2 includes a first end connected to the input node 32a and a second end connected to the output node 32b.

The switch 322 is arranged on the signal line L1, and is turned on/off in accordance with the upper flag MAXᵢ. The switch 322 is turned on and activates a part of the signal line L1, when the upper flag MAXᵢ is at the active level (the H level or level “1”). The switch 322 is turned off and deactivates the part of the signal line L1, when the upper flag MAXᵢ is at the non-active level (the L level or level “0”). The switch 322 includes a first end connected to the input node 32a and a second end connected to a data input node D of the register 321-i.

The switch 323 is arranged on the signal line L1, and is turned on/off in accordance with the upper flag MAXᵢ. The switch 323 is turned on and activates a part of the signal line L1, when the upper flag MAXᵢ is at the active level (the H level or level “1”). The switch 323 is turned off and deactivates the part of the signal line L1, when the upper flag MAXᵢ is at the non-active level (the L level or level “0”). The switch 323 includes a first end connected to an output node Q of the register 321-i and a second end connected to the output node 32b.

The switch 324 is arranged on the bypass line L2, and is turned on/off in accordance with an inversion upper flag MAXᵢ . The inversion upper flag MAXᵢ is obtained by logically inverting the upper flag MAXᵢ. The switch 324 is turned on and activates the bypass line L2, when the inversion upper flag MAXᵢ is at the active level (the H level or level “1”). The switch 324 is turned off and deactivates the bypass line L2, when the inversion upper flag MAXᵢ is at the non-active level (the L level or level “0”). The switch 324 includes a first end connected to the input node 32a and a second end connected to the output node 32b.

The switch 325 is arranged between the signal line L1 and the ground potential, and is turned on/off in accordance with the inversion upper flag MAXᵢ . The switch 325 is turned on and sets the signal line L1 to the ground potential (or the L level), when the inversion upper flag MAXᵢ is at the active level (the H level or level “1”). Thus, the switch 325 deactivates the register 321-i. The switch 325 is turned off and cancels the potential setting of the signal line L1, when the inversion upper flag MAXᵢ is at the non-active level (the L level or level “0”). Thus, the switch 325 activates the register 321-i.

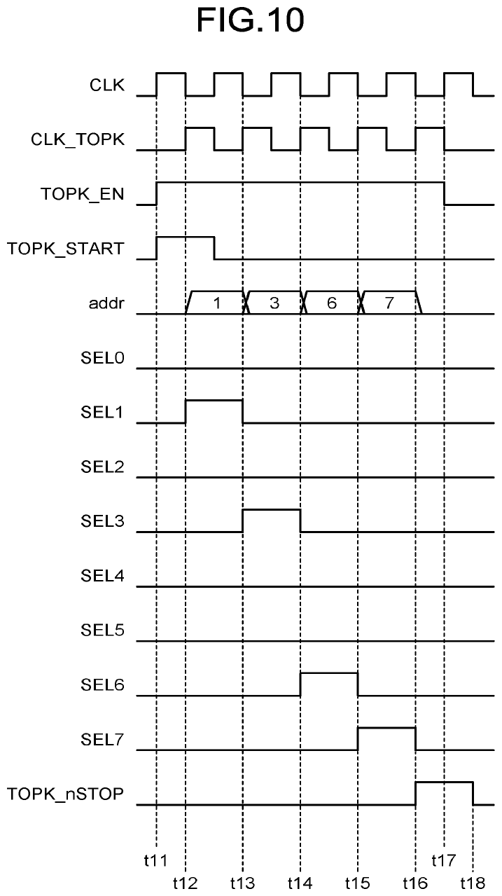

For example, the address solution circuit 3 is operated as illustrated in FIG. 10. FIG. 10 is a waveform diagram illustrating an operation of the address solution circuit 3. FIG. 10 corresponds to a case where the processing circuit 2 is operated as illustrated in FIG. 4. FIG. 10 illustrates an operation in a case where the number of columns is 8 (the 0th column to the 7th column), and the address solution circuit 3 receives the upper flags (MAX₀, MAX₁, MAX₂, MAX₃, MAX₄, MAX₅, MAX₆, MAX₇)=(0, 1, 0, 1, 0, 0, 1, 1) from the processing circuit 2.

At timing t11, in synchronization with the clock CLK, the global circuit 36 (see FIG. 6) causes the enable signal TOPK_EN to transition from the non-active level (for example, the L level) to the active level (for example, the H level), and supplies this signal to the output circuit 34. The output circuit 34 comes into a state ready to output signals present on the address bus addr<0:7>.

In synchronization with the clock CLK, the global circuit 36 generates a single pulse TOPK_START with a pulse width of one period of the clock CLK, and supplies this pulse to the register circuit 32-0 at the top of the shift register 33.

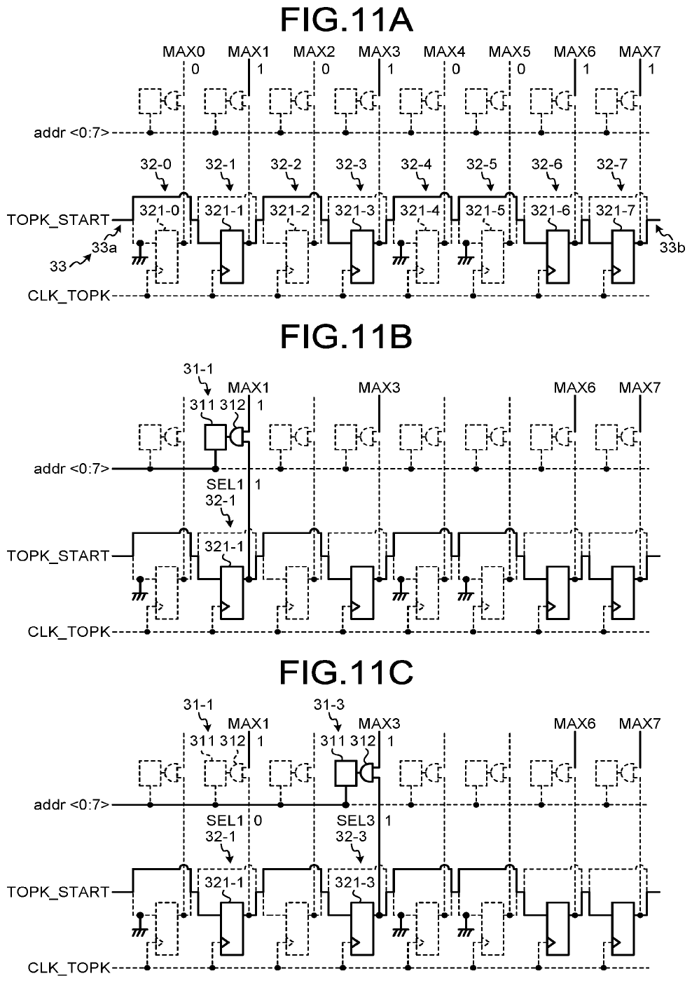

At this time, as illustrated in FIG. 11A, the shift register 33 is reconfigured in accordance with the upper flags (MAX₀, MAX₁, MAX₂, MAX₃, MAX₄, MAX₅, MAX₆, MAX₇)=(0, 1, 0, 1, 0, 0, 1, 1).

In accordance with the upper flag MAX₀=0 and the inversion upper flag MAX₀ =1, the register circuit 32-0 is switched to the second connection state where the register 321 is bypassed between the input node 32a and the output node 32b.

In accordance with the upper flag MAX₁=1 and the inversion upper flag MAX₁ =0, the register circuit 32-1 is switched to the first connection state where the register 321 is connected between the input node 32a and the output node 32b.

In accordance with the upper flag MAX₂=0 and the inversion upper flag MAX₂ =1, the register circuit 32-2 is switched to the second connection state where the register 321 is bypassed between the input node 32a and the output node 32b.

In accordance with the upper flag MAX₃=1 and the inversion upper flag MAX₃ =0, the register circuit 32-3 is switched to the first connection state where the register 321 is connected between the input node 32a and the output node 32b.

In accordance with the upper flag MAX₄=0 and the inversion upper flag MAX₄ =1, the register circuit 32-4 is switched to the second connection state where the register 321 is bypassed between the input node 32a and the output node 32b.

In accordance with the upper flag MAX₅=0 and the inversion upper flag MAX₅ =1, the register circuit 32-5 is switched to the second connection state where the register 321 is bypassed between the input node 32a and the output node 32b.

In accordance with the upper flag MAX₆=1 and the inversion upper flag MAX₆ =0, the register circuit 32-6 is switched to the first connection state where the register 321 is connected between the input node 32a and the output node 32b.

In accordance with the upper flag MAX₇=1 and the inversion upper flag MAX₇ =0, the register circuit 32-7 is switched to the first connection state where the register 321 is connected between the input node 32a and the output node 32b.

In the example of FIG. 11A, the address solution circuit 3 forms connection between the input node 32a and the output node 32b through the register 321 in each of the register circuit 32-1, 32-3, 32-6, and 32-7 corresponding to the upper flag MAX=1. Further, the address solution circuit 3 forms connection between the input node 32a and the output node 32b while bypassing the register 321 in each of the register circuit 32-0, 32-2, 32-4, and 32-5 corresponding to the upper flag MAX=0. As a result, the shift register 33 is reconfigured such that the registers 321-1, 321-3, 321-6, and 321-7 are selectively connected between the input node 33a and the output node 33b. The registers 321-1, 321-3, 321-6, and 321-7 correspond to the upper K signals identified by the processing circuit 2.

At timing t12 illustrated in FIG. 10, in accordance with a rising edge of the clock CLK_TOPK, the pulse TOPK_START is held in the register 321-1 at the top of the reconfigured shift register 33, and the output of the register 321-1 changes from 0 to 1. Correspondingly, as illustrated in FIG. 11B, the select signal SEL1 changes from 0 to 1, and the enable circuit 312 of the address circuit 31-1 sets the common line E to the active level (for example, the H level) and sets the common line nE to the active level (for example, the L level). Consequently, the storage circuit 311 of the address circuit 31-1 is activated. The storage circuit 311 outputs an address value of the signals corresponding to the upper flag MAX₁ to the address bus addr<0:7>. The lines B0 to B7 respectively output levels of (B0, B1, B2, B3, B4, B5, B6, B7)=(1, 0, 0, 0, 0, 0, 0, 0) as address signals to the corresponding address lines addr. In this example, since B0 corresponds to LSB and B7 corresponds to MSB, the address value is “00000001” in binary notation and “1” in decimal notation.

At timing t13 illustrated in FIG. 10, in accordance with a rising edge of the clock CLK_TOPK, the pulse TOPK_START is shifted from the top register 321-1 to the second register 321-3 in the reconfigured shift register 33. Thus, the output of the register 321-1 changes from 1 to 0, and the output of the register 321-3 changes from 0 to 1.

Correspondingly, as illustrated in FIG. 11C, the select signal SEL1 changes from 1 to 0, and the enable circuit 312 of the address circuit 31-1 sets the common line E to the non-active level (for example, the L level) and sets the common line nE to the non-active level (for example, the H level). Consequently, the storage circuit 311 of the address circuit 31-1 is deactivated.

Together with the above, the select signal SEL3 changes from 0 to 1, and the enable circuit 312 of the address circuit 31-3 sets the common line E to the active level (for example, the H level) and sets the common line nE to the active level (for example, the L level). Consequently, the storage circuit 311 of the address circuit 31-3 is activated. The storage circuit 311 outputs an address value of the signals corresponding to the upper flag MAX₃ to the address bus addr<0:7>. The lines B0 to B7 respectively output levels of (B0, B1, B2, B3, B4, B5, B6, B7)=(1, 1, 0, 0, 0, 0, 0, 0) as address signals to the corresponding address lines addr. In this example, since B0 corresponds to LSB and B7 corresponds to MSB, the address value is “00000011” in binary notation and “3” in decimal notation.

At timing t14 illustrated in FIG. 10, in accordance with a rising edge of the clock CLK_TOPK, the pulse TOPK_START is shifted from the second register 321-3 to the third register 321-6 in the reconfigured shift register 33. Thus, the output of the register 321-3 changes from 1 to 0, and the output of the register 321-6 changes from 0 to 1.

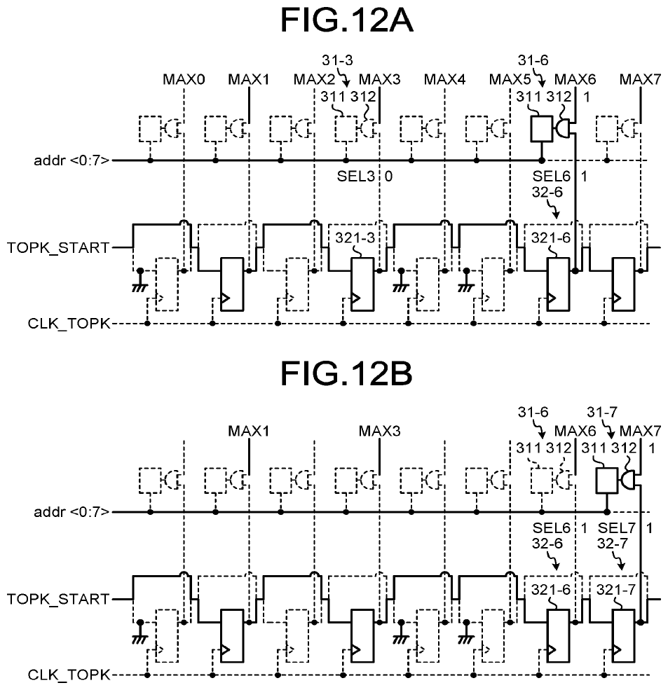

Correspondingly, as illustrated in FIG. 12A, the select signal SEL3 changes from 1 to 0, and the enable circuit 312 of the address circuit 31-3 sets the common line E to the non-active level (for example, the L level) and sets the common line nE to the non-active level (for example, the H level). Consequently, the storage circuit 311 of the address circuit 31-3 is deactivated.

Together with the above, the select signal SEL6 changes from 0 to 1, and the enable circuit 312 of the address circuit 31-6 sets the common line E to the active level (for example, the H level) and sets the common line nE to the active level (for example, the L level). Consequently, the storage circuit 311 of the address circuit 31-6 is activated. The storage circuit 311 outputs an address value of the signals corresponding to the upper flag MAX₆ to the address bus addr<0:7>. The lines B0 to B7 respectively output levels of (B0, B1, B2, B3, B4, B5, B6, B7)=(0, 1, 1, 0, 0, 0, 0, 0) as address signals to the corresponding address lines addr. In this example, since B0 corresponds to LSB and B7 corresponds to MSB, the address value is “00000110” in binary notation and “6” in decimal notation.

At timing t15 illustrated in FIG. 10, in accordance with a rising edge of the clock CLK_TOPK, the pulse TOPK_START is shifted from the third register 321-6 to the final register 321-7 in the reconfigured shift register 33. Thus, the output of the register 321-6 changes from 1 to 0, and the output of the register 321-7 changes from 0 to 1.

Correspondingly, as illustrated in FIG. 12B, the select signal SEL6 changes from 1 to 0, and the enable circuit 312 of the address circuit 31-6 sets the common line E to the non-active level (for example, the L level) and sets the common line nE to the non-active level (for example, the H level). Consequently, the storage circuit 311 of the address circuit 31-6 is deactivated.

Together with the above, the select signal SEL7 changes from 0 to 1, and the enable circuit 312 of the address circuit 31-7 sets the common line E to the active level (for example, the H level) and sets the common line nE to the active level (for example, the L level). Consequently, the storage circuit 311 of the address circuit 31-7 is activated. The storage circuit 311 outputs an address value of the signals corresponding to the upper flag MAX₇ to the address bus addr<0:7>. The lines B0 to B7 respectively output levels of (B0, B1, B2, B3, B4, B5, B6, B7)=(1, 1, 1, 0, 0, 0, 0, 0) as address signals to the corresponding address lines addr. In this example, since B0 corresponds to LSB and B7 corresponds to MSB, the address value is “00000111” in binary notation and “7” in decimal notation.

At timing t16 illustrated in FIG. 10, in accordance with a rising edge of the clock CLK_TOPK, the pulse TOPK_START is transferred from the final register 321-7 of the shift register 33 to the transfer detection circuit 35. Thus, the output of the register 321-7 changes from 1 to 0, and the output of the transfer detection circuit 35 changes from 0 to 1.

Correspondingly, the select signal SEL7 changes from 1 to 0, and the enable circuit 312 of the address circuit 31-7 sets the common line E to the non-active level (for example, the L level) and sets the common line nE to the non-active level (for example, the H level). Consequently, the storage circuit 311 of the address circuit 31-7 is deactivated. Together with this, the transfer detection circuit 35 supplies the output that has become 1 to the global circuit 36 as the pulse TOPK_nSTOP.

In accordance with the pulse TOPK_nSTOP, at timing t17, the global circuit 36 causes the enable signal TOPK_EN to transition from the active level (for example, the H level) to the non-active level (for example, the L level), and supplies this signal to the output circuit 34, in synchronization with the clock CLK. The output circuit 34 comes into a state not to output signals present on the address bus addr<0:7>. Consequently, the outputting of address signals from the address solution circuit 3 to the address bus addr<0:7> is completed.

At timing t18, the output of the transfer detection circuit 35 changes from 1 to 0, and notification from the transfer detection circuit 35 to the global circuit 36 is completed.

The address solution in the calculation system 1 is performed in a sequence of the following (1) to (3).

(1) In the array of a plurality of memory elements that form a plurality of rows and a plurality of columns, a product-sum operation is performed by calculating the product between the word line voltage input to each row and the weight of each memory element, and adding up these products as the bit line current of each column. The processing circuit 2 processes the signals of the product-sum operation results on a plurality of columns, and generates a plurality of upper flags MAX corresponding to the plurality of columns. Among the product-sum operation results of the plurality of columns, the processing circuit 2 sets the upper flags corresponding to the upper K product-sum operation results to MAX=1, and sets the remaining upper flags to MAX=0. The upper flags MAX of the plurality of columns are supplied from the processing circuit 2 to the address solution circuit 3.

(2) In accordance with the upper flags of the plurality of columns, the address solution circuit 3 performs address solution to the signals of the upper K product-sum operation results among the product-sum operation results of the plurality of columns. That is, among a plurality of register circuits that correspond to the plurality of columns and each include a register, the address solution circuit 3 connects the register between the input and output nodes, in each register circuit corresponding to the upper flag MAX=1, and bypasses the register between the input and output nodes, in each register circuit corresponding to the upper flag MAX=0. Consequently, the address solution circuit 3 selectively connects K registers 321 corresponding to the upper flag MAX=1, among the registers of the plurality of register circuits, between the input and output nodes of the shift register 33, and thereby reconfigures the shift register 33 as a K bit shift register.

(3) The address solution circuit 3 propagates a pulse of one bit sequentially to the registers 321 at K stages in the reconfigured shift register 33, and, in accordance with this, sequentially and selectively enables K address circuits corresponding to the upper K among the plurality of address circuits corresponding to the plurality of columns. In each enabled address circuit, address signals stored by, for example, hard-wired connection are output to the address bus. Consequently, the address values corresponding to the upper K product-sum operation results are sequentially output, and the address solution in K cycles is realized.

As described above, according to the first embodiment, in the address solution circuit 3 of the calculation system 1, the plurality of address circuits 31 are provided corresponding to the plurality of columns of the memory array MA. Further, in accordance with the upper flags of the plurality of columns, the address circuits 31 corresponding to the upper K product-sum operation results, among the product-sum operation results of the plurality of columns, are selectively and sequentially enabled and caused to output address values. Consequently, the address solution for the upper K signals can be performed by an operation in cycles corresponding to K (smaller than or equal to the number of columns), and thus the address solution for the upper K signals can be performed more efficiently. Therefore, for example, when the upper K of a plurality of signals output from the plurality of columns of the memory array MA are required for use, the plurality of signals can be efficiently utilized.

For example, when the address solution for the upper K signals is performed in linear search, the respective columns of the plurality of columns are sequentially selected. The upper flag value of each selected column is checked, and the address value is output when the upper flag MAX=1, but the address value is not output when the upper flag MAX=0. This processing is performed sequentially for the respective columns of the plurality of columns. Therefore, the address solution is performed by an operation in cycles corresponding to the number of columns.

On the other hand, according to the first embodiment, the address solution for the upper K signals can be performed by an operation in cycles corresponding to K smaller than or equal to the number of columns. Therefore, the address solution for the upper K signals can be performed more efficiently.

Further, according to the first embodiment, in the address solution circuit 3 of the calculation system 1, each of the plurality of address circuits 31 stores the address value in a hard-wired configuration, and the shift register 33 is reconfigured such that K registers are selectively used in accordance with the upper flags of the plurality of columns. Consequently, the shift register 33 can be reconfigured such that the address solution for the K address signals corresponding to the upper K signals can be performed in K cycles. Therefore, the address solution circuit 3 can be configured in a scalable manner for the “K” number of uppers. That is, the address solution for the upper K signals can be performed more scalably. It follows that the circuit design for the address solution circuit 3 can be facilitated, and the area of the address solution circuit 3 can be reduced.

### Second Embodiment

Next, a calculation system 401 according to a second embodiment will be described. Hereinafter, an explanation will be given by mainly focusing on part different from the first embodiment.

In the first embodiment, the configuration and operation for address solution have been illustrated for the upper K signals. On the other hand, in the second embodiment, the configuration and operation for address solution will be illustrated for the lower K signals.

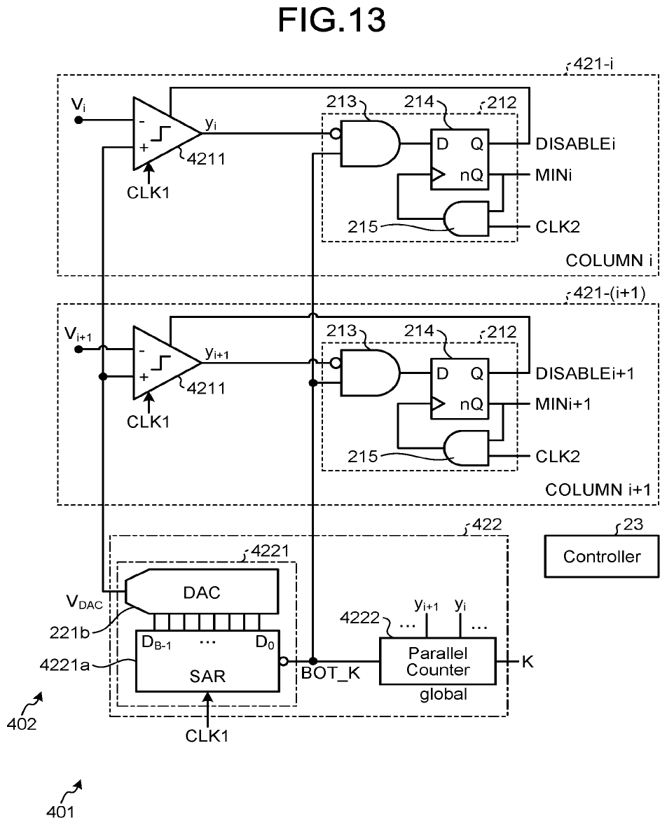

The calculation system 401 includes a processing circuit 402 and an address solution circuit 403 in place of the processing circuit 2 and the address solution circuit 3 (see FIG. 2). As illustrated in FIG. 13, the processing circuit 402 is configured to search for the lower K values. The processing circuit 402 is a circuit that searches for the lower K values while performing AD-conversion operations of the SAR-type. FIG. 13 is a circuit diagram illustrating a configuration of the processing circuit 402 in the second embodiment.

The local circuit 421-i, 421-(i+1) in each column includes a comparator 4211, which is in a state where the two input terminals of the comparator 211 (see FIG. 3) are swapped. Each comparator 4211 receives a signal Vᵢ, Vᵢ₊₁ at the inversion input terminal (−) and a global reference signal V_{DAC} at the non-inversion input terminal (+).

In a global circuit 422, a parallel counter 4222 counts how many outputs among the local signals yᵢ, yᵢ₊₁, etc. output from the comparators 4211 of the respective columns are at the H level (or 1), in each DA conversion cycle, and outputs a global signal BOT_K to an AND gate 213 for each column and a global SAR register 4221a in accordance with the counted value. In searching for the lower K values, the parallel counter 4222 outputs the global signal BOT_K=H level (or 1) when the counted value is greater than or equal to K, and outputs the global signal BOT_K=L level (or 0) when the counted value is smaller than K. When the global signal BOT_K is supplied, the global SAR register 4221a stores a value obtained by logically inverting the value of the global signal BOT_K, in the register at the first stage, and shifts the value held in the register at each stage.

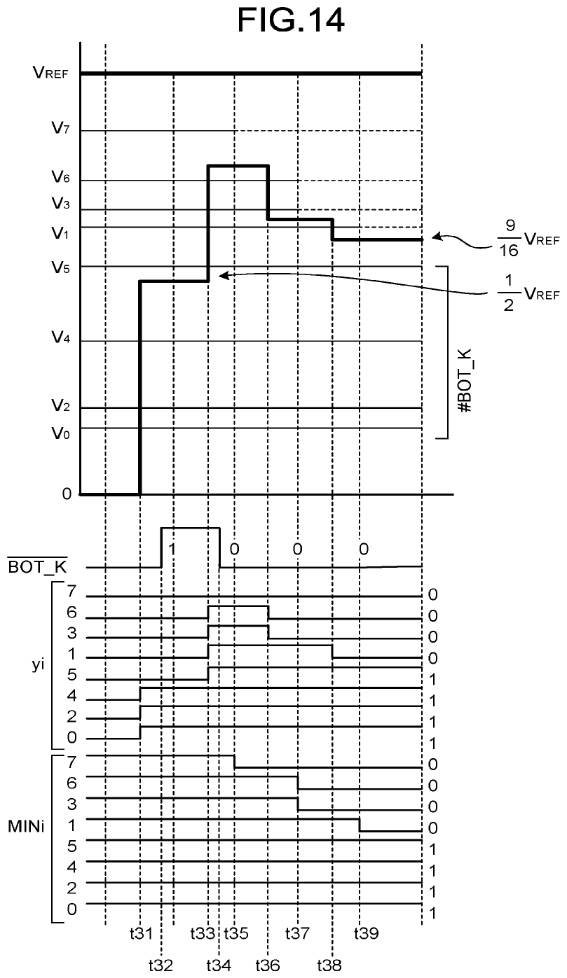

With this configuration, the processing circuit 402 searches for the lower K values while performing AD-conversion operations of the SAR-type, as illustrated in FIG. 14. FIG. 14 is a waveform diagram illustrating an operation of the processing circuit 402 in the second embodiment. In the upper part of FIG. 14, the vertical axis indicates the magnitude of voltage and the horizontal axis indicates time. In the lower part of FIG. 14, the vertical axis indicates the level of each signal (for example, the H level or L level), and the horizontal axis indicates time. In the upper and lower parts of FIG. 14, the horizontal axes indicate the same time. FIG. 14 illustrates the case of K=4.

The comparator 4211 in each column receives the signal Vᵢ at the inversion input terminal (−), and receives the global reference voltage V_{DAC} at the non-inversion input terminal (+). Accordingly, when the signal Vᵢ is lower than the global reference voltage V_{DAC}, the comparator 4211 outputs the local signal yᵢ=1, and, when the signal Vᵢ is higher than the global reference voltage V_{DAC}, the comparator 4211 outputs the local signal yᵢ=0.

For example, at timing t31, the DAC 4221 for the global SAR sets the global reference voltage V_{DAC}=V_{REF}/2. The comparators 4211 for the respective columns compare the signals V₀ to V₇ with the reference voltage V_{DAC}=V_{REF}/2, and output local signals (y₀, y₁, y₂, y₃, y₄, y₅, y₆, y₇)=(1, 0, 1, 0, 1, 0, 0, 0) as comparison results. Correspondingly, the parallel counter 4222 counts the number of local signals yᵢ whose value is 1. Since the counted value=3 is smaller than K=4, at timing t32, the global signal BOT_K changes to the L level (or 0), and a global signal inversion signal BOT_K changes to the H level (or 1). FIG. 14 shows the level of the inversion signal BOT_K . This means that the number of signals lower than the global reference signal V_{DAC} is smaller than K.

At timing t33, the DAC 4221 for the global SAR sets the global reference voltage V_{DAC}=3V_{REF}/4. The comparators 4211 for the respective columns compare the signals V₀ to V₇ with the reference voltage V_{DAC}=3V_{REF}/4, and outputs local signals (y₀, y₁, y₂, y₃, y₄, y₅, y₆, y₇)=(1, 1, 1, 1, 1, 1, 1, 0) as comparison results. The parallel counter 4222 counts the number of local signals yᵢ whose value is 1. Since the counted value=7 is greater than or equal to K=4, at timing t34, the global signal BOT_K changes to the H level (or 1), and the global signal inversion signal BOT_K changes to the L level (or 0). In this case, since it is not possible to determine which signal of a plurality of signals V₀ to V₆ belongs to the lower K signals, the determination is suspended.

At timing t35, in the local circuit 421 for each of the 0th to 6th columns (i=0 to 6), since the comparator 4211 outputs the local signal yᵢ=1, while the global signal BOT_K=1, the flip-flop 214 keeps its output in the original state. That is, the flip-flop 214 for each of the 0th to 6th columns keeps the lower flag at MINᵢ=H (or 1) and keeps the disable signal at DISABLEᵢ=L (or 0). On the other hand, in the local circuit 421 for the 7th column (i=7), since the comparator 4211 outputs the local signal yᵢ=0, while the global signal BOT_K=1, the flip-flop 214 changes its output from the original state. That is, the flip-flop 214 for the 7th column changes the lower flag from MINᵢ=H (or 1) to MINᵢ=L (or 0) and changes the disable signal from DISABLEᵢ=L (or 0) to DISABLEᵢ=H (or 1).

Consequently, at timing t35 and thereafter, the comparator 4211 for the 7th column (i=7) receives the disable signal DISABLEᵢ=H (or 1) and is disabled in operation. Therefore, as shown by a dotted line in the Vᵢ waveform in FIG. 14, the power consumption of the comparator 4211 is stopped (power gating).

At timing t36, the DAC 4221 for the global SAR sets the global reference voltage V_{DAC}=5V_{REF}/8. The comparators 4211 for the respective columns (the 0th to 6th columns) not disabled at this time compare the signals V₀ to V₆ with the global reference voltage V_{DAC}=5V_{REF}/8, and output local signals (y₀, y₁, y₂, y₃, y₄, y₅, y₆)=(1, 1, 1, 0, 1, 1, 0) as comparison results. Then, the parallel counter 4222 counts the number of local signals whose value is 1. Since the counted value=5 is greater than or equal to K=4, the global signal BOT_K is kept at the H level (or 1), and the global signal inversion signal BOT_K is kept at the L level (or 0).

At timing t37, in the local circuit 421 for each of the 0th to 2nd, 4th, and 5th columns (i=0 to 2, 4, 5), since the comparator 4211 outputs the local signal yᵢ=1, while the global signal BOT_K=1, the flip-flop 214 keeps its output in the original state. That is, the flip-flop 214 for each of the 0th to 2nd, 4th, and 5th columns keeps the lower flag at MINᵢ=H (or 1) and keeps the disable signal at DISABLEᵢ=L (or 0). On the other hand, in the local circuit 421 for each of the 3rd and 6th columns (i=3, 6), since the comparator 4211 outputs the local signal yᵢ=0, while the global signal BOT_K=1, the flip-flop 214 changes its output from the original state. That is, the flip-flop 214 for each of the 3rd and 6th columns changes the lower flag from MINᵢ=H (or 1) to MINᵢ=L (or 0) and changes the disable signal from DISABLEᵢ=L (or 0) to DISABLEᵢ=H (or 1).

Consequently, at timing t37 and thereafter, the comparator 4211 for each of the 3rd and 6th columns (i=3, 6) receives the disable signal DISABLEᵢ=H (or 1) and is disabled in operation. Therefore, as shown by a dotted line in the Vᵢ waveform in FIG. 14, the power consumption of the comparator 4211 is stopped (power gating).

At timing t38, the DAC 4221 for the global SAR sets the global reference voltage V_{DAC}=9V_{REF}/16. The comparators 4211 for the respective columns (the 0th to 2nd, 4th, and 5th columns) not disabled at this time compare the signals V₀ to V₂, V₄, and V₅ with the global reference voltage V_{DAC}=9V_{REF}/16, and output local signals (y₀, y₁, y₂, y₄, y₅)=(1, 0, 1, 1, 1) as comparison results. Then, the parallel counter 4222 counts the number of local signals whose value is 1. Since the counted value=4 is greater than or equal to K=4, the global signal BOT_K is kept at the H level (or 1), and the global signal inversion signal BOT_K is kept at the L level (or 0).

At timing t39, in the local circuit 421 for each of the 0th, 2nd, 4th, and 5th columns (i=0, 2, 4, 5), since the comparator 4211 outputs the local signal yᵢ=1, while the global signal BOT_K=1, the flip-flop 214 keeps its output in the original state. That is, the flip-flop 214 for each of the 0th, 2nd, 4th, and 5th columns keeps the lower flag at MINᵢ=H (or 1) and keeps the disable signal at DISABLEᵢ=L (or 0). On the other hand, in the local circuit 421 for the 1st column (i=1), since the comparator 4211 outputs the local signal yᵢ=0, while the global signal BOT_K=1, the flip-flop 214 changes its output from the original state. That is, the flip-flop 214 for the 1st column changes the lower flag from MINᵢ=H (or 1) to MINᵢ=L (or 0) and changes the disable signal from DISABLEᵢ=L (or 0) to DISABLEᵢ=H (or 1).

Consequently, at timing t39 and thereafter, the comparator 4211 for the 1st column (i=1) receives the disable signal DISABLEᵢ=H (or 1) and is disabled in operation. Therefore, as shown by a dotted line in the Vᵢ waveform in FIG. 14, the power consumption of the comparator 4211 is stopped (power gating).

When B denotes the number of bits according to the precision of conversion, the processing circuit 402 outputs, at timing t33 after B=4 cycles, the lower flags (MIN₀, MIN₁, MIN₂, MIN₃, MIN₄, MIN₅, MIN₆, MIN₇)=(1, 0, 1, 0, 1, 1, 0, 0) as the result of searching for the lower K values. In this example, it is illustrated that, as the result of searching for the lower K values, the signals V₀, V₂, V₄, and V₅ of the 0th, 2nd, 4th, and 5th columns have been found as the lower K values among the signals V₀ to V₇ of the 0th column to the 7th column.

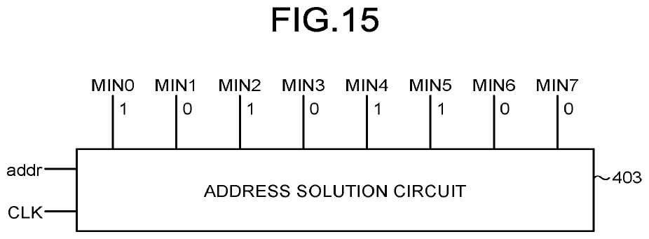

The address solution circuit 403 illustrated in FIG. 15 receives the lower flags (MIN₀, MIN₁, MIN₂, MIN₃, MIN₄, MIN₅, MIN₆, MIN₇)=(1, 0, 1, 0, 1, 1, 0, 0) from the processing circuit 402, and receives the clock CLK from the outside (for example, the controller illustrated in FIG. 13). FIG. 15 is a diagram illustrating the input and output signals of the address solution circuit 403. FIG. 15 illustrates a case where the number of columns is 8. The address solution circuit 403 may logically invert the lower flags to generate inversion lower flags (MIN₀ , MIN1 , MIN₂ , MIN₃ , MIN₄ , MIN₅ , MIN₆ , MIN₇ )=(0, 1, 0, 1, 0, 0, 1, 1). The address solution circuit 403 can use the lower flags MIN, the inversion lower flags MIN , and the clock CLK to perform the address solution for the signals corresponding to the lower flags MIN₀ to MIN₇, and thereby sequentially output the lower K address signals to an address bus addr<0:7>.

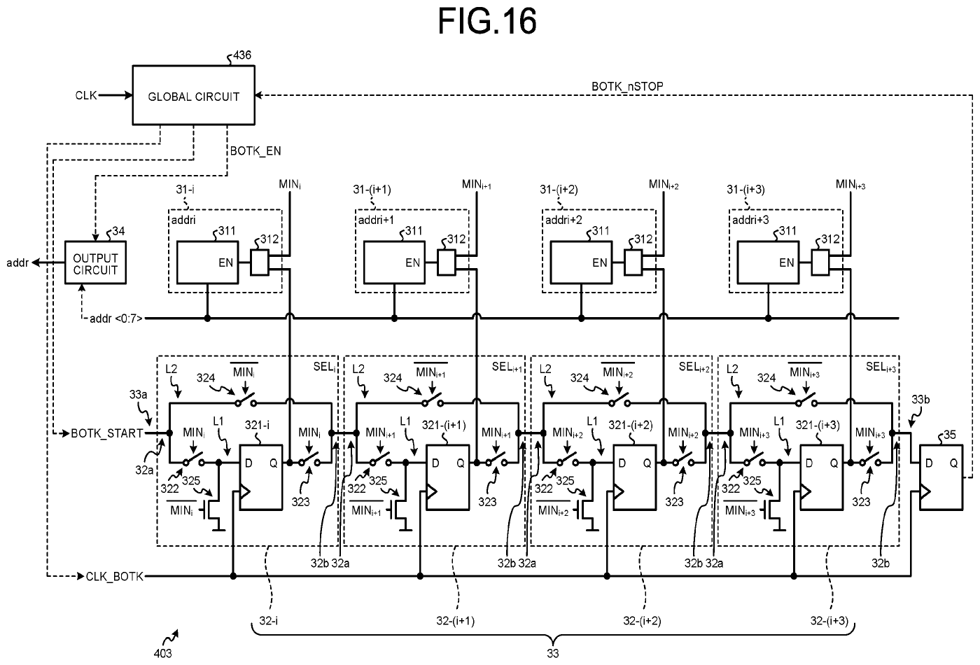

The address solution circuit 403 may be configured as illustrated in FIG. 16. FIG. 16 is a circuit diagram illustrating a schematic configuration of the address solution circuit 403.

As illustrated in FIG. 16, the address solution circuit 403 includes a global circuit 436 in place of the global circuit 36 (see FIG. 6). The global circuit 436 receives the clock CLK from the outside, and generates a clock CLK_BOTK, an enable signal BOTK_EN, and a pulse BOTK_START in accordance with the clock CLK. The global circuit 436 supplies the enable signal BOTK_EN to the output circuit 34, supplies the pulse BOTK_START to the register 321 at the top of the shift register 33, and supplies the clock CLK_BOTK to each register 321 of the shift register 33.

The shift register 33 can be reconfigured in accordance with the lower flags of the plurality of columns. The address solution circuit 403 connects the register 321 between the input node 32a and the output node 32b, in each of the register circuits 32 corresponding to the lower K lower flag values among the plurality of register circuits 32-i to 32-(i+3). The address solution circuit 403 bypasses the register 321 between the input node 32a and the output node 32b, in each of the remaining register circuits 32. With this arrangement, the address solution circuit 403 reconfigures the shift register 33.

The shift register 33 thus reconfigured receives an input of the pulse BOTK_START, which is supplied alone. The shift register 33 transmits the pulse BOTK_START by sequentially shifting this pulse between the registers 321 corresponding to the lower K lower flag values. Correspondingly, the address circuits 31 corresponding to the lower K lower flag values among the plurality of address circuits 31-i to 31-(i+3) are selectively and sequentially enabled. Consequently, the address signals are sequentially output from the address circuits 31 corresponding to the lower K lower flag values to the address bus addr<0:7>. That is, the shift register 33 can be reconfigured such that the address solution for the K address signals corresponding to the lower K signals can be performed in K cycles. Therefore, the address solution circuit 403 can be configured in a scalable manner for the “K” number of lowers.

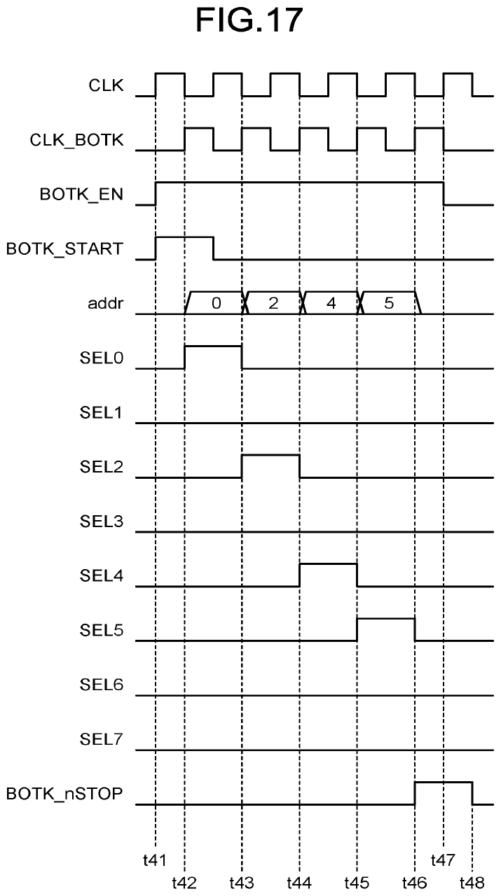

For example, the address solution circuit 403 is operated as illustrated in FIG. 17. FIG. 17 is a waveform diagram illustrating an operation of the address solution circuit 403. FIG. 17 corresponds to a case where the processing circuit 402 is operated as illustrated in FIG. 14. FIG. 17 illustrates an operation in a case where the number of columns is 8 (the 0th column to the 7th column), and the address solution circuit 403 receives the lower flags (MIN₀, MIN₁, MIN₂, MIN₃, MIN₄, MIN₅, MIN₆, MIN₇)=(1, 0, 1, 0, 1, 1, 0, 0,) from the processing circuit 402.

At timing t41, in synchronization with the clock CLK, the global circuit 436 (see FIG. 16) causes the enable signal BOTK_EN to transition from the non-active level (for example, the L level) to the active level (for example, the H level), and supplies this signal to the output circuit 34. The output circuit 34 comes into a state ready to output signals present on the address bus addr<0:7>.

In synchronization with the clock CLK, the global circuit 436 generates a single pulse BOTK_START with a pulse width of one period of the clock CLK, and supplies this pulse to the register circuit 32-0 at the top of the shift register 33.

At this time, the shift register 33 is reconfigured in accordance with the lower flags (MIN₀, MIN₁, MIN₂, MIN₃, MIN₄, MIN₅, MIN₆, MIN₇)=(1, 0, 1, 0, 1, 1, 0, 0). For example, the address solution circuit 403 forms connection between the input node 32a and the output node 32b through the register 321 in each of the register circuits 32-0, 32-2, 32-4, and 32-5 (see FIG. 11A) corresponding to the lower flag MIN=1. Further, the address solution circuit 403 forms connection between the input node 32a and the output node 32b while bypassing the register 321 in each of the register circuits 32-1, 32-3, 32-6, and 32-7 corresponding to the upper flag MIN=0. As a result, the shift register 33 is reconfigured such that the registers 321-0, 321-2, 321-4, and 321-5 are selectively connected between the input node 33a and the output node 33b. The registers 321-0, 321-2, 321-4, and 321-5 correspond to the lower K signals identified by the processing circuit 402.

At timing t42, in accordance with a rising edge of the clock CLK_BOTK, the pulse BOTK_START is held in the register 321-0 at the top of the reconfigured shift register 33, and the output of the register 321-0 changes from 0 to 1. Correspondingly, the select signal SEL0 changes from 0 to 1, and the enable circuit 312 of the address circuit 31-0 sets the common line E to the active level (for example, the H level) and sets the common line nE to the active level (for example, the L level). Consequently, the storage circuit 311 of the address circuit 31-0 is activated. The storage circuit 311 outputs an address value of the signals corresponding to the lower flag MIN₀ to the address bus addr<0:7>. The lines B0 to B7 respectively output levels of (B0, B1, B2, B3, B4, B5, B6, B7)=(0, 0, 0, 0, 0, 0, 0, 0) as address signals to the corresponding address lines addr. In this example, since B0 corresponds to LSB and B7 corresponds to MSB, the address value is “00000000” in binary notation and “0” in decimal notation.

At timing t43, in accordance with a rising edge of the clock CLK_BOTK, the pulse BOTK_START is shifted from the top register 321-0 to the second register 321-2 in the reconfigured shift register 33. Thus, the output of the register 321-0 changes from 1 to 0, and the output of the register 321-2 changes from 0 to 1.

Correspondingly, the select signal SEL0 changes from 1 to 0, and the enable circuit 312 of the address circuit 31-0 sets the common line E to the non-active level (for example, the L level) and sets the common line nE to the non-active level (for example, the H level). Consequently, the storage circuit 311 of the address circuit 31-0 is deactivated.

Together with the above, the select signal SEL2 changes from 0 to 1, and the enable circuit 312 of the address circuit 31-2 sets the common line E to the active level (for example, the H level) and sets the common line nE to the active level (for example, the L level). Consequently, the storage circuit 311 of the address circuit 31-2 is activated. The storage circuit 311 outputs an address value of the signals corresponding to the lower flag MIN₂ to the address bus addr<0:7>. The lines B0 to B7 respectively output levels of (B0, B1, B2, B3, B4, B5, B6, B7)=(0, 1, 0, 0, 0, 0, 0, 0) as address signals to the corresponding address lines addr. In this example, since B0 corresponds to LSB and B7 corresponds to MSB, the address value is “00000010” in binary notation and “2” in decimal notation.

At timing t44, in accordance with a rising edge of the clock CLK_BOTK, the pulse BOTK_START is shifted from the second register 321-2 to the third register 321-4 in the reconfigured shift register 33. Thus, the output of the register 321-2 changes from 1 to 0, and the output of the register 321-4 changes from 0 to 1.

Correspondingly, the select signal SEL2 changes from 1 to 0, and the enable circuit 312 of the address circuit 31-2 sets the common line E to the non-active level (for example, the L level) and sets the common line nE to the non-active level (for example, the H level). Consequently, the storage circuit 311 of the address circuit 31-2 is deactivated.

Together with the above, the select signal SEL4 changes from 0 to 1, and the enable circuit 312 of the address circuit 31-4 sets the common line E to the active level (for example, the H level) and sets the common line nE to the active level (for example, the L level). Consequently, the storage circuit 311 of the address circuit 31-4 is activated. The storage circuit 311 outputs an address value of the signals corresponding to the lower flag MIN₄ to the address bus addr<0:7>. The lines B0 to B7 respectively output levels of (B0, B1, B2, B3, B4, B5, B6, B7)=(0, 0, 1, 0, 0, 0, 0, 0) as address signals to the corresponding address lines addr. In this example, since B0 corresponds to LSB and B7 corresponds to MSB, the address value is “00000100” in binary notation and “4” in decimal notation.

At timing t45, in accordance with a rising edge of the clock CLK_BOTK, the pulse BOTK_START is shifted from the third register 321-4 to the final register 321-5 in the reconfigured shift register 33. Thus, the output of the register 321-4 changes from 1 to 0, and the output of the register 321-5 changes from 0 to 1.

Correspondingly, the select signal SEL4 changes from 1 to 0, and the enable circuit 312 of the address circuit 31-4 sets the common line E to the non-active level (for example, the L level) and sets the common line nE to the non-active level (for example, the H level). Consequently, the storage circuit 311 of the address circuit 31-4 is deactivated.

Together with the above, the select signal SELS changes from 0 to 1, and the enable circuit 312 of the address circuit 31-5 sets the common line E to the active level (for example, the H level) and sets the common line nE to the active level (for example, the L level). Consequently, the storage circuit 311 of the address circuit 31-5 is activated. The storage circuit 311 outputs an address value of the signals corresponding to the lower flag MIN₅ to the address bus addr<0:7>. The lines B0 to B7 respectively output levels of (B0, B1, B2, B3, B4, B5, B6, B7)=(1, 0, 1, 0, 0, 0, 0, 0) as address signals to the corresponding address lines addr. In this example, since B0 corresponds to LSB and B7 corresponds to MSB, the address value is “00000101” in binary notation and “5” in decimal notation.

At timing t46, in accordance with a rising edge of the clock CLK_BOTK, the pulse BOTK_START is transferred from the final register 321-5 of the shift register 33 to the transfer detection circuit 35. Thus, the output of the register 321-5 changes from 1 to 0, and the output of the transfer detection circuit 35 changes from 0 to 1.

Correspondingly, the select signal SEL5 changes from 1 to 0, and the enable circuit 312 of the address circuit 31-5 sets the common line E to the non-active level (for example, the L level) and sets the common line nE to the non-active level (for example, the H level). Consequently, the storage circuit 311 of the address circuit 31-5 is deactivated. Together with this, the transfer detection circuit 35 supplies the output that has become 1 to the global circuit 436 as the pulse BOTK_nSTOP.

In accordance with the pulse BOTK_nSTOP, at timing t47, the global circuit 436 causes the enable signal BOTK_EN to transition from the active level (for example, the H level) to the non-active level (for example, the L level), and supplies this signal to the output circuit 34, in synchronization with the clock CLK. The output circuit 34 comes into a state not to output signals present on the address bus addr<0:7>. Consequently, the outputting of address signals from the address solution circuit 403 to the address bus addr<0:7> is completed.

At timing t48, the output of the transfer detection circuit 35 changes from 1 to 0, and notification from the transfer detection circuit 35 to the global circuit 436 is completed.

As described above, according to the second embodiment, the address solution for the lower K signals can be performed by an operation in cycles corresponding to K smaller than or equal to the number of columns, and thus the address solution for the lower K signals can be performed more efficiently. Therefore, for example, when the lower K of a plurality of signals output from the plurality of columns of the memory array MA are required for use, the plurality of signals can be efficiently utilized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A calculation system comprising:
a plurality of multiplying elements arrayed to form a plurality of rows and a plurality of columns, and configured to multiply a plurality of first signals by respective weights to generate a plurality of calculation results;
a plurality of adding elements configured to calculate a sum of calculation results in each column among the plurality of calculation results to generate a plurality of second signals individually for the plurality of columns;
a first processing circuit configured to receive the plurality of second signals generated by the adding elements, and to extract values corresponding to certain second signals among the plurality of second signals; and
a second processing circuit including a plurality of address circuits corresponding to the plurality of second signals, and configured to selectively enable address circuits corresponding to the certain second signals among the plurality of address circuits.

2. The calculation system according to claim 1, wherein
the second processing circuit further includes a shift register that includes a plurality of register circuits corresponding to the plurality of address circuits, the shift register being configured to be reconfigurable.

3. The calculation system according to claim 2, wherein
the first processing circuit is configured to generate a plurality of upper flag values individually for the plurality of second signals, each of which indicates whether a corresponding second signal is one of second signals of upper K levels among the plurality of second signals, where K is an integer of 1 or more,
each of the plurality of register circuits includes an input node, an output node, and a register, and
the second processing circuit is configured to reconfigure the shift register by forming connection between the input node and the output node through the register, in each of register circuits corresponding to upper flag values indicative of being the second signals of the upper K levels, among the plurality of register circuits, and by forming connection between the input node and the output node while bypassing the register, in each of remaining register circuits.

4. The calculation system according to claim 3, wherein
each of the plurality of register circuits further comprises:
a first switching element configured to turn on to connect the register between the input node and the output node,
a second switching element configured to turn on to bypass the register between the input node and the output node, and
each of the address circuits comprises:
a storage circuit configured to store an address value, the storage circuit including an enable terminal, and
an enable circuit that includes a first input node configured to receive a corresponding one of the upper flag values, a second input node connected to an output node of the register, and an output node connected to the enable terminal of the storage circuit.

5. The calculation system according to claim 4, wherein
each of the plurality of register circuits further comprises a third switching element configured to turn on to deactivate the register, and to turn off to activate the register.

6. The calculation system according to claim 4, wherein
the storage circuit is configured to fixedly store an address value.

7. The calculation system according to claim 4, wherein
the storage circuit includes a plurality of lines each connected to a fixed potential.

8. The calculation system according to claim 4, wherein
the enable circuit is configured to enable or disable the storage circuit in accordance with a corresponding one of the upper flag values, and an output value of the register, and
the storage circuit is configured to output an address value to an address line when being in an enabled state, and not to output any address value to the address line when being in a disabled state.

9. The calculation system according to claim 8, wherein
the address circuit comprises:
a transfer detection circuit connected to a final register in the shift register, and
an output circuit connected to the address line, and configured to output signals present on the address line since a pulse is input to the shift register until the transfer detection circuit detects output of the pulse.

10. The calculation system according to claim 4, wherein
the enable circuit is configured to enable the storage circuit when a corresponding one of the upper flag values is at a first level and an output value of the register is at the first level, and to disable the storage circuit when the corresponding one of the upper flag values is at a second level or an output value of the register is at the second level.

11. The calculation system according to claim 4, wherein
the enable circuit comprises:
a negative logical multiplication circuit that includes a first input node configured to receive a corresponding one of the upper flag values, a second input node connected to the output node of the register, and an output node connected to a first enable terminal of the storage circuit, and
an inverter that includes an input node connected to the output node of the negative logical multiplication circuit, and an output node connected to a second enable terminal of the storage circuit.

12. The calculation system according to claim 2, wherein
the first processing circuit is configured to generate a plurality of lower flag values individually for the plurality of second signals, each of which indicates whether a corresponding second signal is one of second signals of lower K levels among the plurality of second signals, where K is an integer of 1 or more,
each of the plurality of register circuits includes an input node, an output node, and a register, and
the second processing circuit is configured to reconfigure the shift register by forming connection between the input node and the output node through the register, in each of register circuits corresponding to lower flag values indicative of being the second signals of the lower K levels, among the plurality of register circuits, and by forming connection between the input node and the output node while bypassing the register, in each of remaining register circuits.

13. The calculation system according to claim 12, wherein
each of the plurality of register circuits further comprises:
a first switching element configured to turn on to connect the register between the input node and the output node,
a second switching element configured to turn on to bypass the register between the input node and the output node, and
each of the address circuits comprises:
a storage circuit configured to store an address value, the storage circuit including an enable terminal, and
an enable circuit that includes a first input node configured to receive a corresponding one of the lower flag values, a second input node connected to an output node of the register, and an output node connected to the enable terminal of the storage circuit.

14. The calculation system according to claim 13, wherein
each of the plurality of register circuits further comprises a third switching element configured to turn on to deactivate the register, and to turn off to activate the register.

15. The calculation system according to claim 13, wherein
the storage circuit is configured to fixedly store an address value.

16. The calculation system according to claim 13, wherein
the storage circuit includes a plurality of lines each connected to a fixed potential.

17. The calculation system according to claim 13, wherein
the enable circuit is configured to enable or disable the storage circuit in accordance with a corresponding one of the lower flag values, and an output value of the register, and
the storage circuit is configured to output an address value to an address line when being in an enabled state, and not to output any address value to the address line when being in a disabled state.

18. The calculation system according to claim 17, wherein
the address circuit comprises:
a transfer detection circuit connected to a final register in the shift register, and
an output circuit connected to the address line, and configured to output signals present on the address line since a pulse is input to the shift register until the transfer detection circuit detects output of the pulse.

19. The calculation system according to claim 13, wherein
the enable circuit is configured to enable the storage circuit when a corresponding one of the lower flag values is at a first level and an output value of the register is at the first level, and to disable the storage circuit when the corresponding one of the lower flag values is at a second level or an output value of the register is at the second level.

20. The calculation system according to claim 13, wherein
the enable circuit comprises:
a negative logical multiplication circuit that includes a first input node configured to receive a corresponding one of the lower flag values, a second input node connected to the output node of the register, and an output node connected to a first enable terminal of the storage circuit, and
an inverter that includes an input node connected to the output node of the negative logical multiplication circuit, and an output node connected to a second enable terminal of the storage circuit.
